(19) United States
(12) Patent Application Publication
(10) Pub. No.: US 2013/0253753 A1
(43) Pub. Date: Sep. 26, 2013

(54) DETECTING LANE MARKINGS

(71) Applicants: Donald Jason Burnette, Mountain View, CA (US); David I. Ferguson, San Francisco, CA (US)

(72) Inventors: Donald Jason Burnette, Mountain View, CA (US); David I. Ferguson, San Francisco, CA (US)

(73) Assignee: GOOGLE INC., Mountain View, CA (US)

(21) Appl. No.: 13/427,964

(22) Filed: Mar. 23, 2012

(51) Int. Cl. G05D 1/00; G06K 9/00

(52) U.S. Cl. 701/26; 382/104

(57) ABSTRACT

Aspects of the disclosure relate generally to detecting lane markers. More specifically, laser scan data may be collected by moving a laser along a roadway. The laser scan data may include data points describing the intensity and location information of objects within range of the laser. Each beam of the laser may be associated with a respective subset of data points. For a single beam, the subset of data points may be further divided into sections. For each section, the average intensity and standard deviation may be used to determine a threshold intensity. A set of lane marker data points may be generated by comparing the intensity of each data point to the threshold intensity for the section in which the data point appears and based on the elevation of the data point. This set may be stored for later use or otherwise made available for further processing.

### CROSS-REFERENCE TO RELATED APPLICATION(S)

This patent application is related to copending U.S. Patent Application No. ______ entitled “ESTIMATING ROAD LANE GEOMETRY USING LANE MARKER OBSERVATIONS,” filed concurrently herewith on ______, the entire disclosure of which is hereby incorporated by reference herein.

### BACKGROUND

Autonomous vehicles use various computing systems to aid in the transport of passengers from one location to another. Some autonomous vehicles may require an initial input or continuous input from an operator, such as a pilot, driver, or passenger. Other autonomous systems, for example autopilot systems, may be used only when the system has been engaged, which permits the operator to switch from a manual mode (where the operator exercises a high degree of control over the movement of the vehicle) to an autonomous mode (where the vehicle essentially drives itself) to modes that lie somewhere in between.

Such vehicles are typically equipped with various types of sensors in order to detect objects in the surroundings. For example, autonomous vehicles may include lasers, sonar, radar, cameras, and other devices which scan and record data from the vehicle's surroundings. Sensor data from one or more of these devices may be used to detect objects and their respective characteristics (position, shape, heading, speed, etc.). This detection and identification is a critical function for the safe operation of autonomous vehicle.

In some autonomous driving systems, features such as lane markers are ignored by the autonomous driving system. When the lane markers are ignored, the autonomous vehicle may maneuver itself by relying more heavily on map information and geographic location estimates. This may be less useful in areas where the map information is unavailable, incomplete, or inaccurate.

Some non-real time systems, such as those systems which do not need to process the information and make driving decisions in real time, may use cameras to identify lane markers. For example, map makers may use camera images to identify lane lines. This may involve processing images in order to detect visual road markings such as painted lane boundaries in one or more camera images. However, the quality of camera images is dependent upon the lighting conditions when the image is captured. In addition, the camera images must be projected onto the ground or compared to other images in order to determine the geographic location of objects in the image.

### BRIEF SUMMARY

One aspect of the disclosure provides a method. The method includes accessing scan data collected for a roadway. The scan data includes a plurality of data points having location and intensity information for objects. The method also includes dividing the plurality of data points into sections; for each section, identifying a threshold intensity; generating, by a processor, a set of lane marker data points from the plurality of data points by evaluating each particular data point of the plurality by comparing the intensity value for the particular data point to the threshold intensity value for the section of the particular data point; and storing the set of lane marker data points for later use.

In one example, generating the set of lane marker data points also includes selecting data points of the plurality of data points having locations within a threshold elevation of the roadway. In yet another example, dividing the plurality of data points into sections includes processing a fixed number of data points. In a further example, dividing the plurality of data points into sections includes dividing an area scanned by a laser into sections. In still a further example, the method also includes, before storing the set of lane marker data points, filtering the set of lane maker data points based on a comparison between the set of lane marker data points and models of lane markers. In another example, the method also includes, before storing the set of lane marker data points, filtering the set of lane maker data points based on identifying clusters of data points of the set of lane marker data points. In yet another example, the method also includes, before storing the set of lane marker data points, filtering the set of lane maker data points based on the location of the laser when the laser scan data was taken. In a further example, the method also includes using the set of lane marker data points to maneuver an autonomous vehicle in real time. In still a further example, the method includes using the set of lane marker data points to generate map information.

In another example, the scan data is collected using a laser having a plurality of beams, and the accessed scan data is associated with a first beam of the plurality of beams. In this example, the method also includes accessing second scan data associated with a second beam of the plurality of beams, the second scan data including a second plurality of data points having location and intensity information for objects; dividing the second plurality of data points into second sections; for each second section, evaluating the data points of the second section to determine a respective average intensity and a respective standard deviation for intensity; for each second section, determining a threshold intensity based on the respective average intensity and the respective standard deviation for intensity; generating a second set of lane marker data points from the second plurality of data points by evaluating each particular data point of the second plurality by comparing the intensity value for the particular data point to the threshold intensity value for the second section of the particular data point; and storing the second set of lane marker data points for later use.

In another example, the method also includes, for each section, evaluating the data points of the section to determine a respective average intensity and a respective standard deviation for intensity. In this example, identifying the threshold intensity for a given section is based on the respective average intensity and the respective standard deviation for intensity for the given section. In this example, identifying the threshold intensity for a given section also includes multiplying the respective standard deviations by a predetermined value and adding the respective average intensity values. In another example, identifying the threshold intensity for the sections includes accessing a single threshold deviation value.

Another aspect of the disclosure provides a device. The device includes memory for storing a set of lane marker data points. The device also includes a processor coupled to the memory. The processor is configured to access scan data collected for a roadway, the scan data including a plurality of data points having location and intensity information for objects; divide the plurality of data points into sections; for each section, identify a threshold intensity; generate a set of lane marker data points from the plurality of data points by evaluating each particular data point of the plurality comparing the intensity value for the particular data point to the threshold intensity value for the section of the particular data point; and store the set of lane marker data points in the memory for later use.

In one example, the processor is also configured to generate the set of lane marker data points by selecting data points of the plurality of data points having locations within a threshold elevation of the roadway. In yet another example, the processor is also to divide the plurality of data points into sections by processing a fixed number of data points. In a further example, the processor is also configured to divide the plurality of data points into sections includes dividing an area scanned into sections. In still a further example, the processor is also configured to, before storing the set of lane marker data points, filter the set of lane maker data points based on a comparison between the set of lane marker data points and models of lane markers. In another example, the processor is also configured to, before storing the set of lane marker data points, filter the set of lane maker data points based on identifying clusters of data points of the set of lane marker data points. In a further example, the processor is also configured to, before storing the set of lane marker data points, filter the set of lane maker data points based on the location of the laser when the laser scan data was taken. In still a further example, the processor is further configured to use the set of lane marker data points to maneuver an autonomous vehicle in real time. In another example, the processor is configured to use the set of lane marker data points to generate map information. In yet another example, the processor is also configured to, for each section, evaluate the data points of the section to determine a respective average intensity and a respective standard deviation for intensity. In this example, the processor is also configured to identify the threshold intensity for a given section based on the respective average intensity and the respective standard deviation for intensity for the given section. In this example, the processor is also configured to identify the threshold intensity for a given section by multiplying the respective standard deviations by a predetermined value and adding the respective average intensity values. In another example, the processor is further configured to identify the threshold intensity for the sections by accessing a single threshold deviation value.

A further aspect of the disclosure provides a tangible computer-readable storage medium on which computer readable instructions of a program are stored. The instructions, when executed by a processor, cause the processor to perform a method. The method includes accessing the scan data collected for a roadway, the scan data including a plurality of data points having location and intensity information for objects; dividing the plurality of data points into sections; for each section, evaluating the data points of the section to determine a respective average intensity and a respective standard deviation for intensity; for each section, determining a threshold intensity based on the respective average intensity and the respective standard deviation for intensity; generating a set of lane marker data points from the plurality of data points by evaluating each particular data point of the plurality by comparing the intensity value for the particular data point to the threshold intensity value for the section of the particular data point; and storing the set of lane marker data points for later use.

### BRIEF DESCRIPTION OF THE DRAWINGS

FIG. 1 is a functional diagram of a system in accordance with aspects of the disclosure.

FIG. 2 is an interior of an autonomous vehicle in accordance with aspects of the disclosure.

FIG. 3A is an exterior of an autonomous vehicle in accordance with aspects of the disclosure.

FIG. 3B is a pictorial diagram of a system in accordance with aspects of the disclosure.

FIG. 3C is a functional diagram of a system in accordance with aspects of the disclosure.

FIG. 4 is a diagram of map information in accordance with aspects of the disclosure.

FIG. 5 is a diagram of laser scan data in accordance with aspects of the disclosure.

FIG. 6 is an example vehicle on a roadway in accordance with aspects of the disclosure.

FIG. 7 is another diagram of laser scan data in accordance with aspects of the disclosure.

FIG. 8 is yet another diagram of laser scan data in accordance with aspects of the disclosure.

FIG. 9 is a further diagram of laser scan data in accordance with aspects of the disclosure.

FIGS. 10A and 10B are diagrams of laser scan data in accordance with aspects of the disclosure.

FIGS. 11A and 11B are further diagrams of laser scan data in accordance with aspects of the disclosure.

FIG. 12 is a flow diagram in accordance with aspects of the disclosure.

### DETAILED DESCRIPTION

In one aspect of the disclosure, laser scan data including a plurality of data points from a plurality of beams of a laser may be collected by moving the laser along a roadway. The data points may describe intensity and location information for the objects from which the laser light was reflected. Each beam of the laser may be associated with a respective subset of data points of the plurality of data points.

For a single beam, the respective subset of data points may be divided into sections. For each section, the respective average intensity and the respective standard deviation for intensity may be determined. A threshold intensity for each section may be determined based on the respective average intensity and the respective standard deviation for intensity. This may be repeated for other beams of the lasers.

A set of lane marker data points from the plurality of data points may be generated. This may include evaluating each data point of the plurality to determine if it is within a threshold elevation of the roadway and by comparing the intensity value for the data point to the threshold intensity value for the data point's respective section. The set of lane marker data points may be stored in memory for later use or otherwise made available for further processing, for example, by an autonomous vehicle.

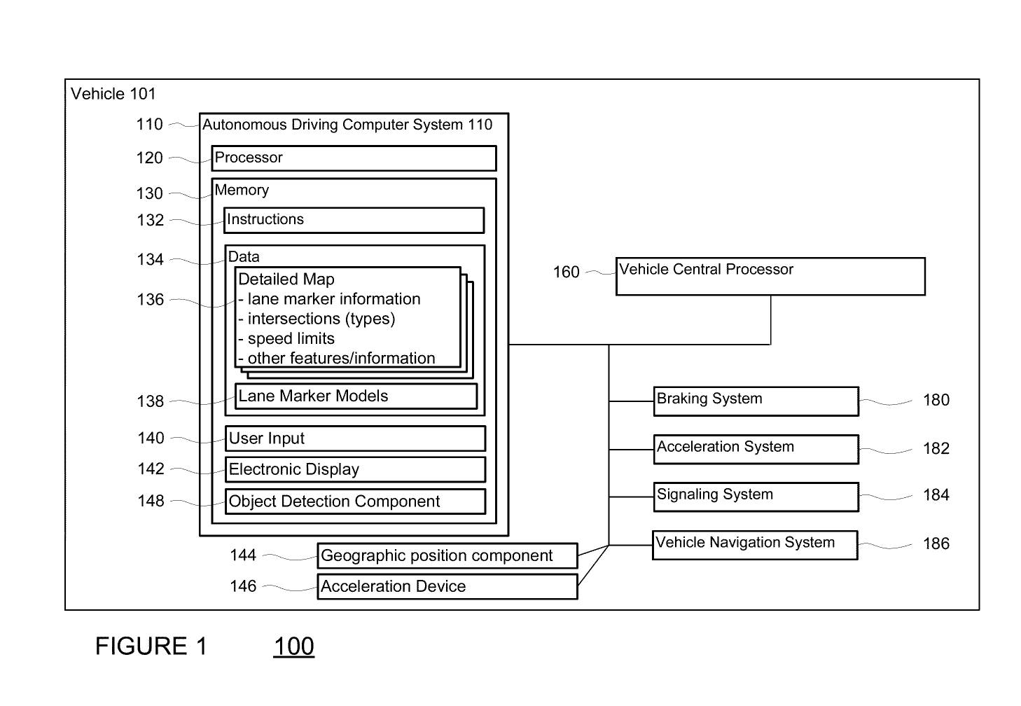

As shown in FIG. 1, an autonomous driving system 100 in accordance with one aspect of the disclosure includes a vehicle 101 with various components. While certain aspects of the disclosure are particularly useful in connection with specific types of vehicles, the vehicle may be any type of vehicle including, but not limited to, cars, trucks, motorcycles, busses, boats, airplanes, helicopters, lawnmowers, recreational vehicles, amusement park vehicles, trams, golf carts, trains, and trolleys. The vehicle may have one or more computers, such as computer 110 containing a processor 120, memory 130 and other components typically present in general purpose computers.

The memory 130 stores information accessible by processor 120, including instructions 132 and data 134 that may be executed or otherwise used by the processor 120. The memory 130 may be of any type capable of storing information accessible by the processor, including a computer-readable medium, or other medium that stores data that may be read with the aid of an electronic device, such as a hard-drive, memory card, ROM, RAM, DVD or other optical disks, as well as other write-capable and read-only memories. Systems and methods may include different combinations of the foregoing, whereby different portions of the instructions and data are stored on different types of media.

The instructions 132 may be any set of instructions to be executed directly (such as machine code) or indirectly (such as scripts) by the processor. For example, the instructions may be stored as computer code on the computer-readable medium. In that regard, the terms “instructions” and “programs” may be used interchangeably herein. The instructions may be stored in object code format for direct processing by the processor, or in any other computer language including scripts or collections of independent source code modules that are interpreted on demand or compiled in advance. Functions, methods and routines of the instructions are explained in more detail below.

The data 134 may be retrieved, stored or modified by processor 120 in accordance with the instructions 132. For instance, although the system and method is not limited by any particular data structure, the data may be stored in computer registers, in a relational database as a table having a plurality of different fields and records, XML documents or flat files. The data may also be formatted in any computer-readable format. By further way of example only, image data may be stored as bitmaps comprised of grids of pixels that are stored in accordance with formats that are compressed or uncompressed, lossless (e.g., BMP) or lossy (e.g., JPEG), and bitmap or vector-based (e.g., SVG), as well as computer instructions for drawing graphics. The data may comprise any information sufficient to identify the relevant information, such as numbers, descriptive text, proprietary codes, references to data stored in other areas of the same memory or different memories (including other network locations) or information that is used by a function to calculate the relevant data.

The processor 120 may be any conventional processor, such as commercially available CPUs. Alternatively, the processor may be a dedicated device such as an ASIC. Although FIG. 1 functionally illustrates the processor, memory, and other elements of computer 110 as being within the same block, it will be understood that the processor and memory may actually comprise multiple processors and memories that may or may not be stored within the same physical housing. For example, memory may be a hard drive or other storage media located in a housing different from that of computer 110. Accordingly, references to a processor or computer will be understood to include references to a collection of processors or computers or memories that may or may not operate in parallel. Rather than using a single processor to perform the steps described herein some of the components, such as steering components and deceleration components, may each have their own processor that only performs calculations related to the component's specific function.

In various aspects described herein, the processor may be located remotely from the vehicle and communicate with the vehicle wirelessly. In other aspects, some of the processes described herein are executed on a processor disposed within the vehicle while others are executed by a remote processor, including taking the steps necessary to execute a single maneuver.

Computer 110 may include all of the components normally used in connection with a computer such as a central processing unit (CPU), memory (e.g., RAM and internal hard drives) storing data 134 and instructions such as a web browser, an electronic display 142 (e.g., a monitor having a screen, a small LCD touch-screen or any other electrical device that is operable to display information), user input 140 (e.g., a mouse, keyboard, touch screen and/or microphone), as well as various sensors (e.g., a video camera) for gathering the explicit (e.g., a gesture) or implicit (e.g., “the person is asleep”) information about the states and desires of a person.

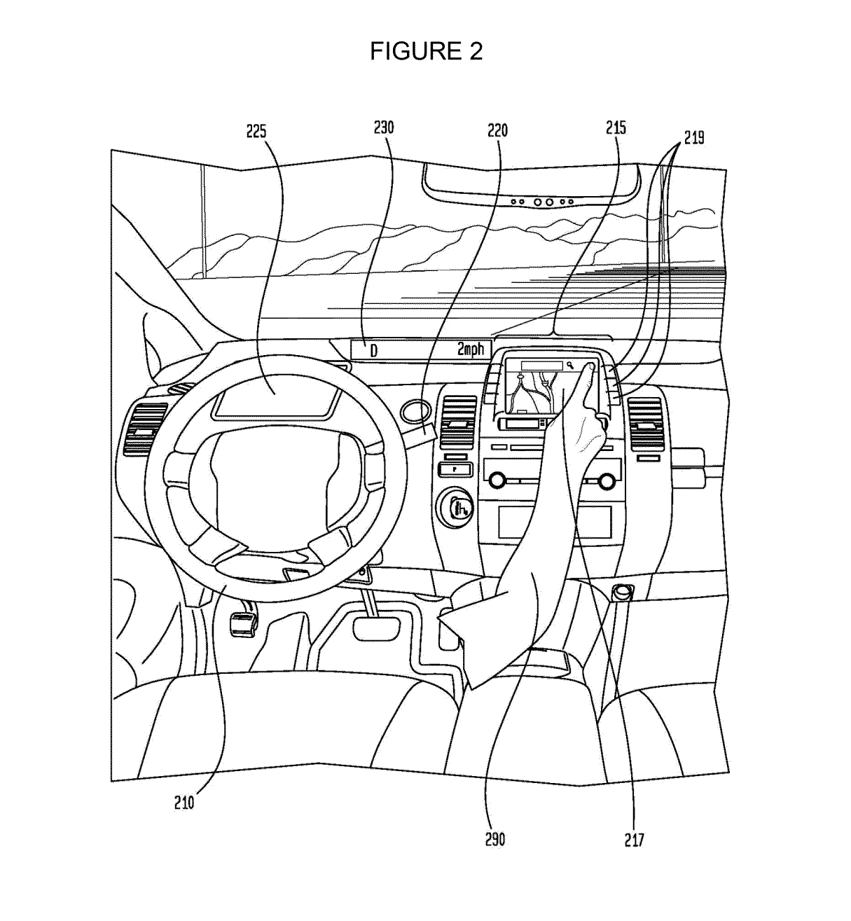

In one example, computer 110 may be an autonomous driving computing system incorporated into vehicle 101. FIG. 2 depicts an exemplary design of the interior of an autonomous vehicle. The autonomous vehicle may include all of the features of a non-autonomous vehicle, for example: a steering apparatus, such as steering wheel 210; a navigation display apparatus, such as navigation display 215; and a gear selector apparatus, such as gear shifter 220. The vehicle may also have various user input devices, such as gear shifter 220, touch screen 217, or button inputs 219, for activating or deactivating one or more autonomous driving modes and for enabling a driver or passenger 290 to provide information, such as a navigation destination, to the autonomous driving computer 110.

Vehicle 101 may also include one or more additional displays. For example, the vehicle may include a display 225 for displaying information regarding the status of the autonomous vehicle or its computer. In another example, the vehicle may include a status indicating apparatus, such as status bar 230, to indicate the current status of vehicle 101. In the example of FIG. 2, status bar 230 displays “D” and “2 mph” indicating that the vehicle is presently in drive mode and is moving at 2 miles per hour. In that regard, the vehicle may display text on an electronic display, illuminate portions of vehicle 101, such as steering wheel 210, or provide various other types of indications.

The autonomous driving computing system may capable of communicating with various components of the vehicle. For example, returning to FIG. 1, computer 110 may be in communication with the vehicle's conventional central processor 160 and may send and receive information from the various systems of vehicle 101, for example the braking 180, acceleration 182, signaling 184, and navigation 186 systems in order to control the movement, speed, etc., of vehicle 101. In addition, when engaged, computer 110 may control some or all of these functions of vehicle 101 and thus be fully or merely partially autonomous. It will be understood that although various systems and computer 110 are shown within vehicle 101, these elements may be external to vehicle 101 or physically separated by large distances.

The vehicle may also include a geographic position component 144 in communication with computer 110 for determining the geographic location of the device. For example, the position component may include a GPS receiver to determine the device's latitude, longitude and/or altitude position. Other location systems such as laser-based localization systems, inertial-aided GPS, or camera-based localization may also be used to identify the location of the vehicle. The location of the vehicle may include an absolute geographical location, such as latitude, longitude, and altitude as well as relative location information, such as location relative to other cars immediately around it which can often be determined with less noise that absolute geographical location.

The vehicle may also include other features in communication with computer 110, such as an accelerometer, gyroscope or another direction/speed detection device 146 to determine the direction and speed of the vehicle or changes thereto. By way of example only, device 146 may determine its pitch, yaw or roll (or changes thereto) relative to the direction of gravity or a plane perpendicular thereto. The device may also track increases or decreases in speed and the direction of such changes. The device's provision of location and orientation data as set forth herein may be provided automatically to the user, computer 110, other computers and combinations of the foregoing.

The computer may control the direction and speed of the vehicle by controlling various components. By way of example, if the vehicle is operating in a completely autonomous mode, computer 110 may cause the vehicle to accelerate (e.g., by increasing fuel or other energy provided to the engine), decelerate (e.g., by decreasing the fuel supplied to the engine or by applying brakes) and change direction (e.g., by turning the front two wheels).

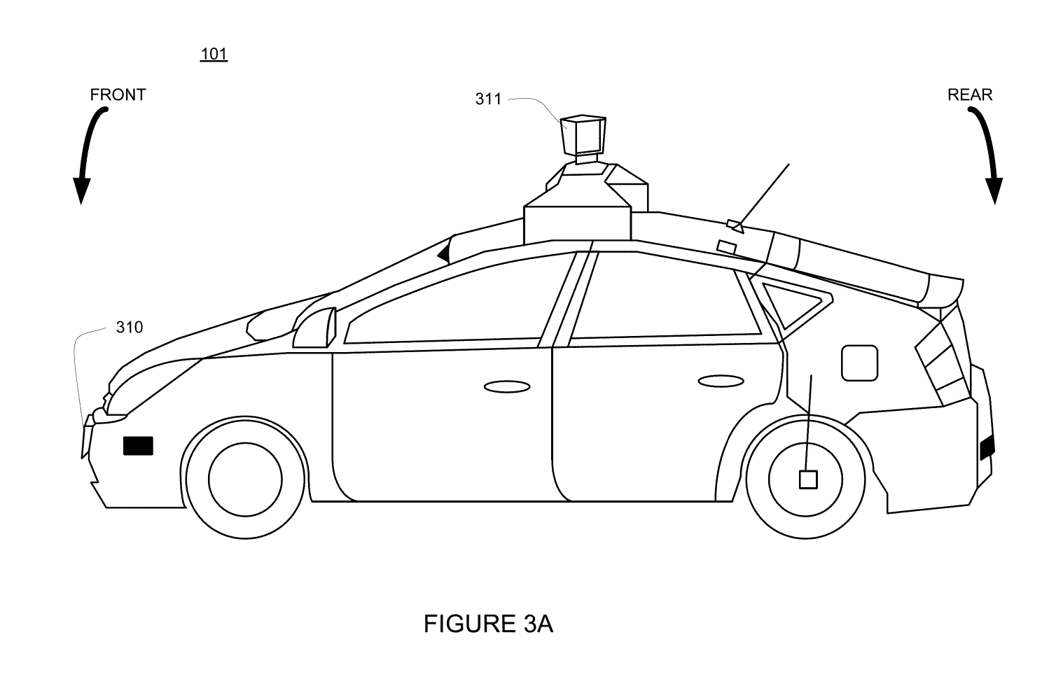

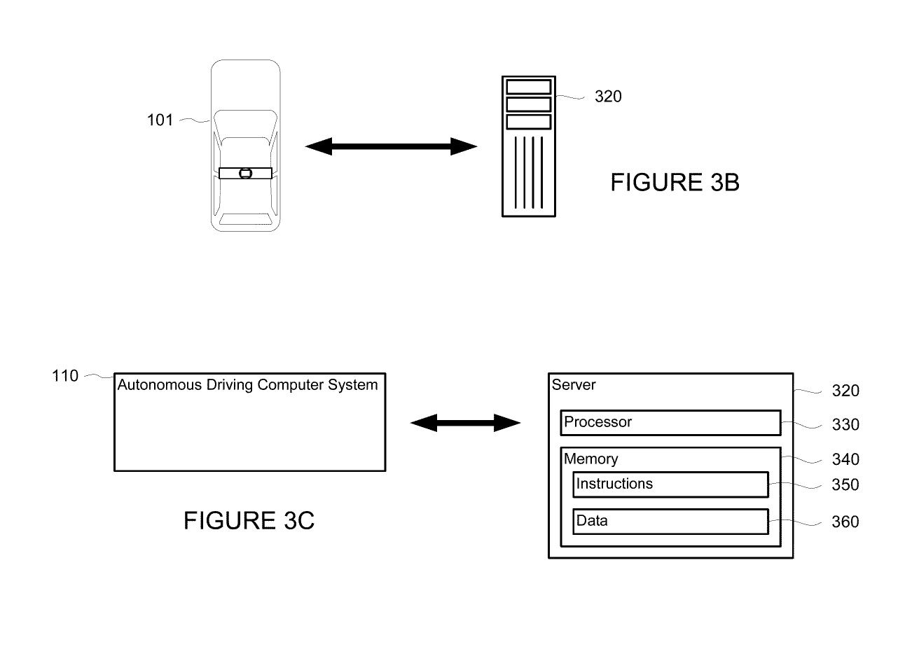

The vehicle may also include components for detecting objects external to the vehicle such as other vehicles, obstacles in the roadway, traffic signals, signs, trees, etc. The detection system may include lasers, sonar, radar, cameras or any other detection devices which record data which may be processed by computer 110. For example, if the vehicle is a small passenger vehicle, the car may include a laser mounted on the roof or other convenient location. As shown in FIG. 3A, vehicle 101 may comprise a small passenger vehicle. In this example, vehicle 101 sensors may include lasers 310 and 311, mounted on the front and top of the vehicle, respectively. The lasers may include commercially available lasers such as the Velodyne HDL-64 or other models. The lasers may include more than one laser beam; for example, a Velodyne HDL64 laser may include 64 beams. In one example, the beams of laser 310 may have a range of 150 meters, a thirty degree vertical field of view, and a thirty degree horizontal field of view. The beams of laser 311 may have a range of 50-80 meters, a thirty degree vertical field of view, and a 360 degree horizontal field of view. It will be understood that other lasers having different ranges and configurations may also be used. The lasers may provide the vehicle with range and intensity information which the computer may use to identify the location and distance of various objects in the vehicles surroundings. In one aspect, the laser may measure the distance between the vehicle and the object surfaces facing the vehicle by spinning on its axis and changing its pitch.

The aforementioned sensors may allow the vehicle to understand and potentially respond to its environment in order to maximize safety for passengers as well as objects or people in the environment. It will be understood that the vehicle types, number and type of sensors, the sensor locations, the sensor fields of view, and the sensors' sensor fields are merely exemplary. Various other configurations may also be utilized.

In addition to the sensors described above, the computer may also use input from sensors typical non-autonomous vehicles. For example, these sensors may include tire pressure sensors, engine temperature sensors, brake heat sensors, brake pad status sensors, tire tread sensors, fuel sensors, oil level and quality sensors, air quality sensors (for detecting temperature, humidity, or particulates in the air), etc.

Many of these sensors provide data that is processed by the computer in real-time, that is, the sensors may continuously update their output to reflect the environment being sensed at or over a range of time, and continuously or as-demanded provide that updated output to the computer so that the computer can determine whether the vehicle's then-current direction or speed should be modified in response to the sensed environment.

In addition to processing data provided by the various sensors, the computer may rely on environmental data that was obtained at a previous point in time and is expected to persist regardless of the vehicle's presence in the environment. For example, returning to FIG. 1, data 134 may include detailed map information 136, e.g., highly detailed maps identifying the shape and elevation of roadways, intersections, crosswalks, speed limits, traffic signals, buildings, signs, real time traffic information, or other such objects and information.

The detailed map information 136 may also include lane marker information identifying the location, elevation, and shape of lane markers. The lane markers may include features such as solid or broken double or single lane lines, solid or broken lane lines, reflectors, etc. A given lane may be associated with left and right lane lines or other lane markers that define the boundary of the lane.

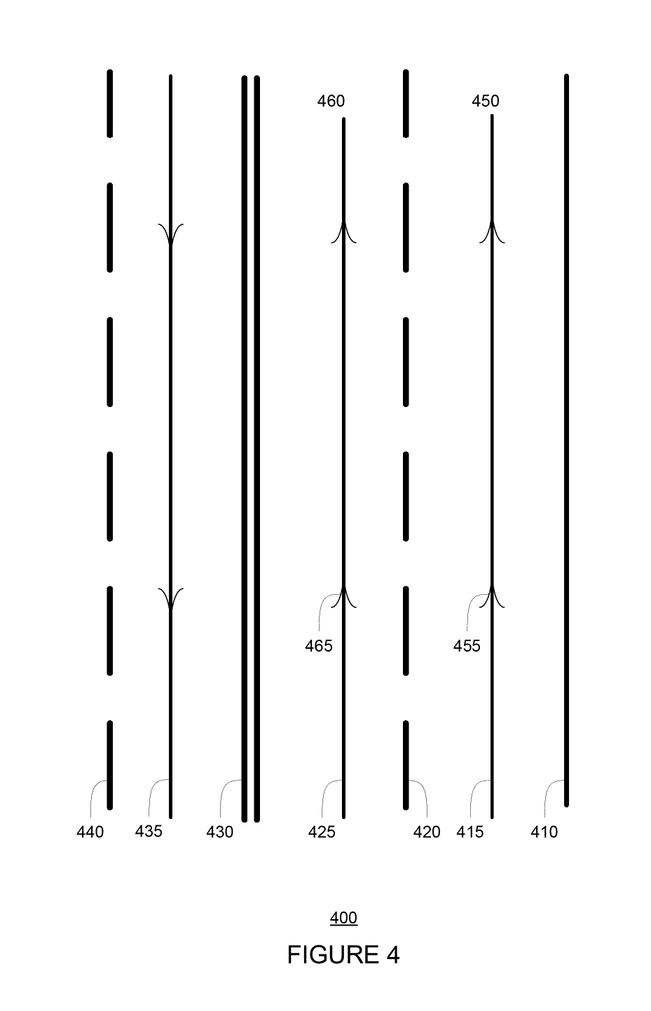

FIG. 4 depicts a detailed map 400 including the same example section of roadway (as well as information outside of the range of the laser). The detailed map of the section of roadway includes information such as solid lane line 410, broken lane lines 420, 440, and double solid lane lines 430. These lane lines define lanes 450 and 460. Each lane is associated with a rail 455, 465 which indicates the direction in which a vehicle should generally travel in the respective lane. For example, a vehicle may follow rail 465 when driving along lane 460.

Again, although the detailed map information is depicted herein as an image-based map, the map information need not be entirely image based (for example, raster). For example, the detailed map information may include one or more roadgraphs or graph networks of information such as roads, lanes, intersections, and the connections between these features. Each feature may be stored as graph data and may be associated with information such as a geographic location and whether or not it is linked to other related features, for example, a stop sign may be linked to a road and an intersection, etc. In some examples, the associated data may include grid-based indices of a roadgraph to allow for efficient lookup of certain roadgraph features.

Computer 110 may also receive or transfer information to and from other computers. For example, the map information stored by computer 110 may be received or transferred from other computers and/or the sensor data collected from the sensors of vehicle 101 may be transferred to another computer for processing as described herein. As shown in FIGS. 3B and 3C, data from computer 110 may be transmitted via a network to computer 320 for further processing. The network, and intervening nodes, may comprise various configurations and protocols including the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computers, such as modems and wireless interfaces. In another example, data may be transferred by storing it on memory which may be accessed by or connected to computers 110 and 320.

In one example, computer 320 may comprise a server having a plurality of computers, e.g., a load balanced server farm, that exchange information with different nodes of a network for the purpose of receiving, processing and transmitting the data from computer 110. The server may be configured similarly to the computer 110, with a processor 330, memory 350, instructions 360, and data 370.

Returning to FIG. 1, data 134 may also include lane marker models 138. The lane marker models may define the geometry of typical lane lines, such as the width, dimensions, relative position to other lane lines, etc. The lane marker models 138 may be stored as a part of map information 136 or separately. The lane marker models may also be stored at the vehicle 101, computer 320 or both.

In addition to the operations described above and illustrated in the figures, various operations will now be described. It should be understood that the following operations do not have to be performed in the precise order described below. Rather, various steps can be handled in a different order or simultaneously, and steps may also be added or omitted.

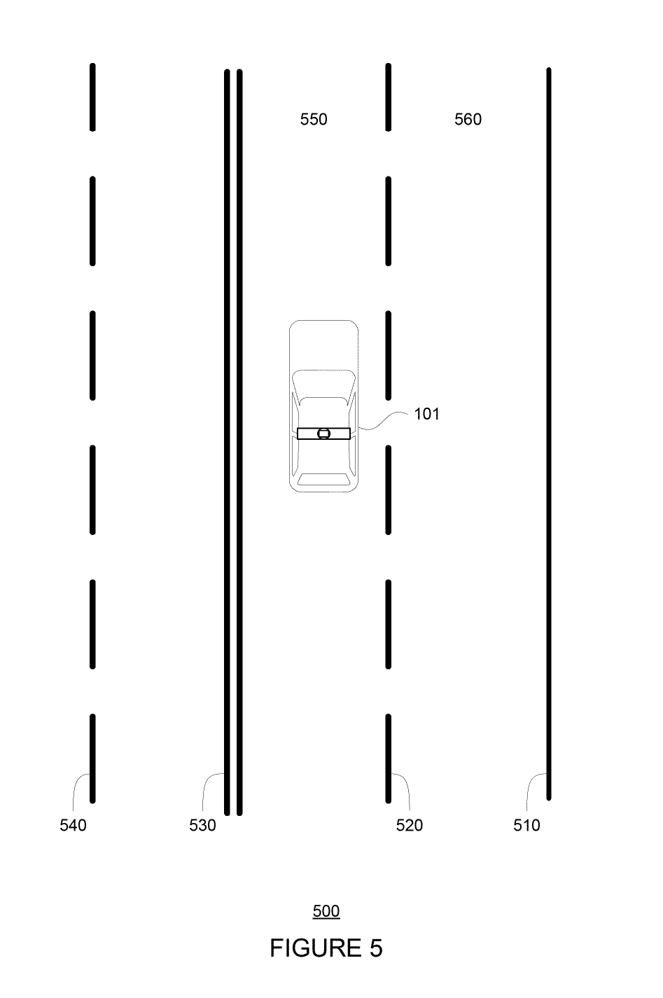

A vehicle including one or more lasers may be driven along a roadway. For example, the laser may be an off board sensor attached to a typical vehicle or a part of an autonomous driving system, such as vehicle 101. FIG. 5 depicts vehicle 101 on a section of the roadway 500 corresponding to the detailed map information of FIG. 4. In this example, the roadway includes solid lane line 510, broken lane lines 520 and 540, double lane lines 530, and lanes 550 and 560.

As the vehicle's laser or lasers are moved along, the laser may collect laser scan data. The laser scan data may include data points having range and intensity information for the same location (point or area) from several directions and/or at different times. For example, the laser scan data may be associated with the particular beam from which the data was provided. Thus, for a single 360 degree scan, each of the beams may provide a set of data points.

As there may be a plurality of beams in a single laser, the data points associated with a single beam may be processed together. For example, the data points for each beam of the beams of laser 311 may be processed by computer 110 (or computer 320) to generate geographic location coordinates. These geographic location coordinates may include GPS latitude and longitude coordinates with a third, elevation component (x,y,z) or may be associated with other coordinate systems. The result of this processing is a set of data point. Each data point of this set may include an intensity value indicative of the reflectivity of the object from which the light was received by the laser as well as a location and elevation component: (x,y,z).

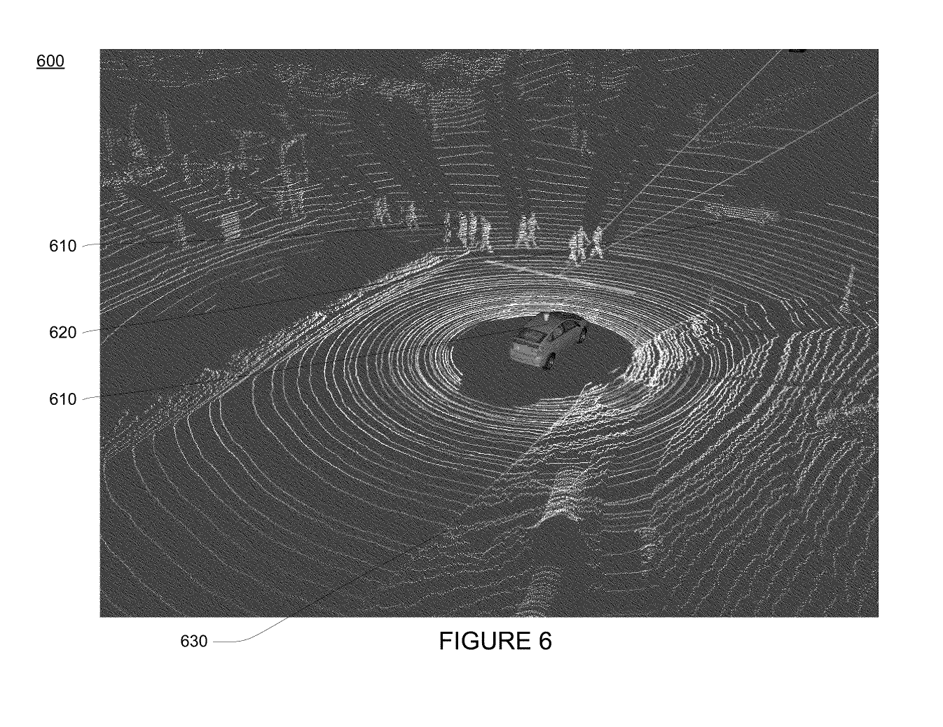

FIG. 6 depicts an exemplary image 600 of vehicle 101 approaching an intersection. The image was generated from laser scan data collected by the vehicle's lasers for a single 360 degree scan of the vehicle's surroundings, for example, using the data points of all of the beams of the collecting laser(s). The white lines represent how the laser “sees” its surroundings. When the data points of a plurality of beams are considered together, the data points may indicate the shape and three-dimensional (3D) location (x,y,z) of other items in the vehicle's surroundings. For example, the laser scan data may indicate the outline, shape and distance from vehicle 101 of various objects such as people 610, vehicles 620, and curb 630.

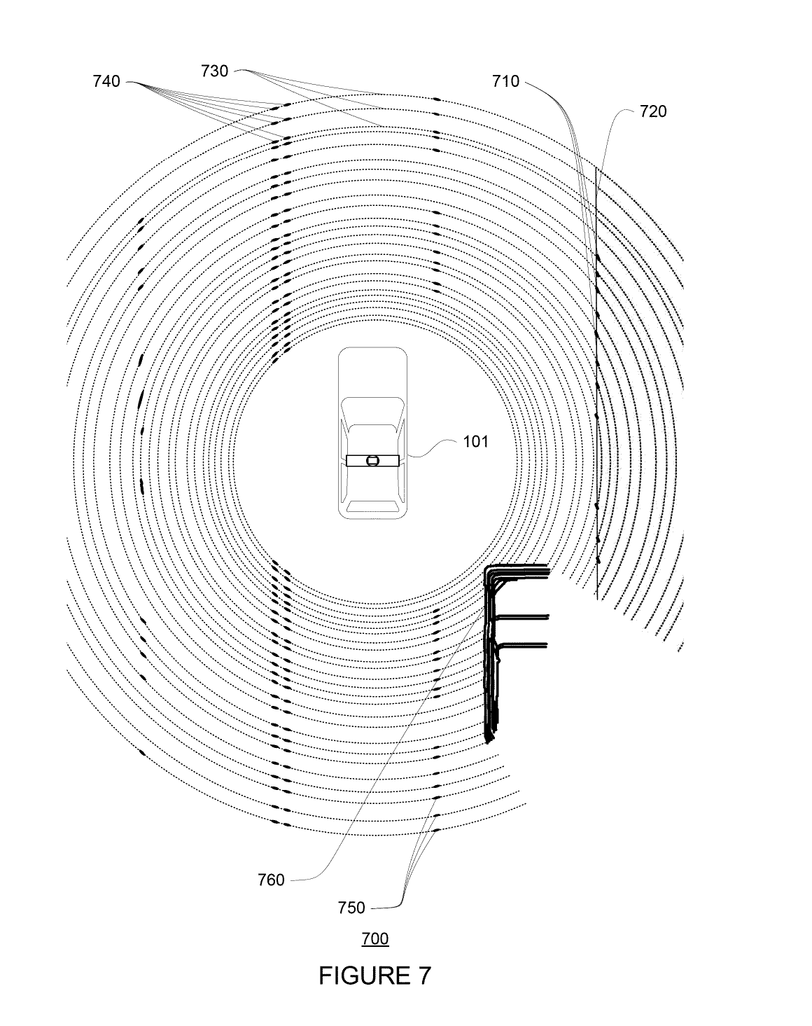

FIG. 7 depicts another example 700 of laser scan data collected for a single scan while a vehicle is driven along roadway 500 of FIG. 5 (and also that depicted in map information 400 of FIG. 4). In the example of FIG. 7, vehicle 101 is depicted surrounded by laser lines 730 indicating the area around the vehicle scanned by the laser. Each laser line may represent a series of discrete data points from a single beam. When the data points of a plurality of beams are considered together, the data points may indicate the shape and three-dimensional (3D) location (x,y,z) of other items in the vehicle's surroundings. Data points from more highly reflective features such as lane lines, white materials (such as paint), reflectors, or those with retroreflective properties may have a greater intensity than less reflective features. In this example, reference line 720 connects the data points 710 associated with a solid lane line and is not part of the laser data.

FIG. 7 also includes data points 740 generated from light reflecting off of then solid double lane lines as well as data points 750 generated form light reflecting off of a broken lane line. In addition to features of the roadway, the laser scan data may data from other objects such as 760 generated from another object in the roadway, such as a vehicle.

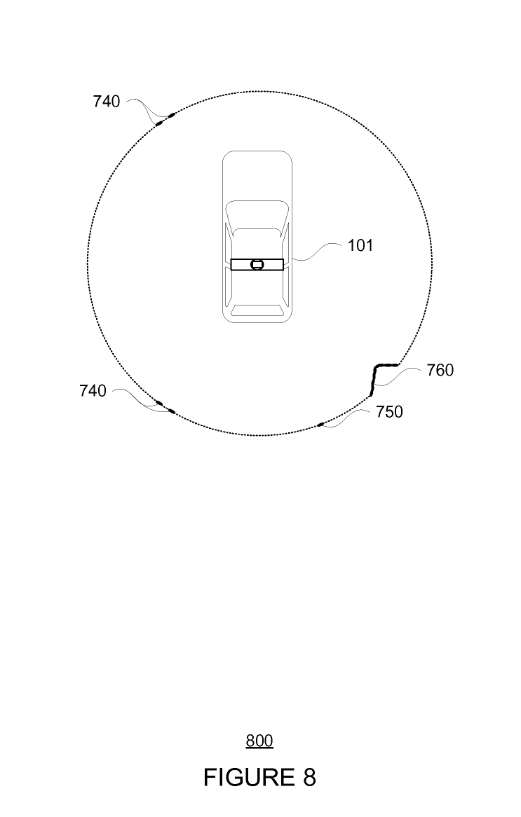

The computer 110 (or computer 320) may compute statistics for a single beam. For example, FIG. 8 is an example 800 of the laser scan data for a single beam. In this example, the data points include data points 740 generated from light reflecting off of the double lane line 530 (shown in FIG. 5), data points 750 generated form light reflecting off of the broken lane line 550 (shown in FIG. 5), and data points 760 generated from another object in the roadway, such as a vehicle.

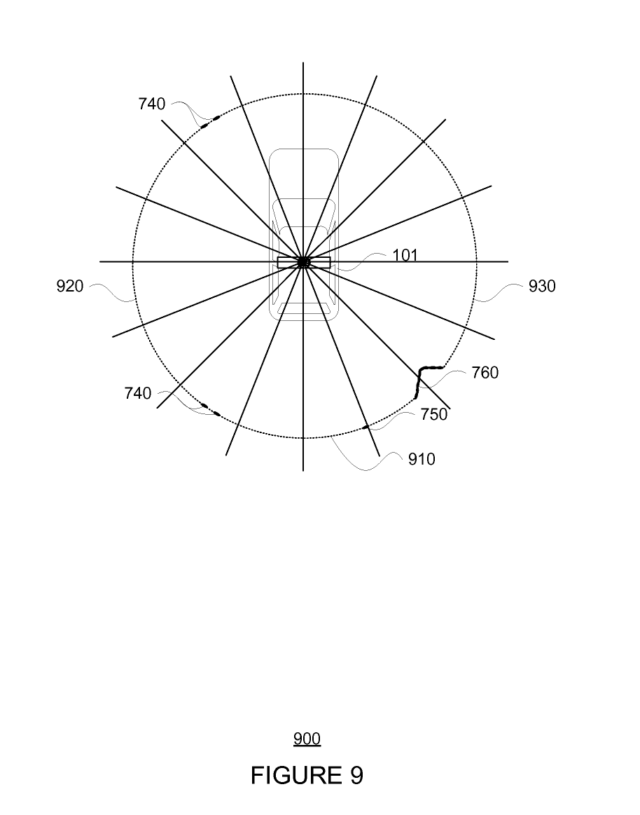

The data points of the beam may be divided into a set of evenly spaced sections for evaluation. FIG. 9 is an example 900 of the laser scan data of FIG. 8 divided into 16 physical sections, including sections 910, 920, and 930. Although only 16 sections are used in the example, many more or less sections may also be used. This sectioning may be performed on a rolling basis, for example, evaluating sets of N data points as they are received by the computer or by physically sectioning the data points after an entire 360 degree scan has been performed.

The average intensity value and standard deviation for each section may be computed. In some examples, the data points may be normalized between or among each of the sections to ensure that the intensity values and standard deviations do not differ too greatly between adjacent sections. This normalization may reduce the noise of the estimates by considering nearby data.

All of the data points for a beam may be evaluated to identify a set of lane marker data points or data points which are likely to correspond to a lane marker. For example, the computer may determine whether each data point meets some criteria for being (or not being) a lane marker. Data points that meet the criteria may be considered to be associated with a lane marker and may be included in a set of possible lane marker data points. In this regard, the computer need not differentiate different lane lines. In other words, the set of possible lane marker data points may include points from a plurality of different lane lines.

In one example, a criterion may be based on the elevation of the data points. In this example, data points with elevation components (z) that are very close to the ground (or roadway surface) are more likely to be associated with a lane marker (or at least associated with the roadway) than points which are greater than a threshold distance above the roadway surface. The road surface information may be included in the map information or may be estimated from the laser scan data. For example, the computer may also fit a surface model to the laser data to identify the ground is and then use this determination for the lane marker data point analysis. Thus, the computer may filter or ignore data points which are above the threshold distance. In other words, data points at or below the threshold elevation may be considered for or included in the set of lane marker data points.

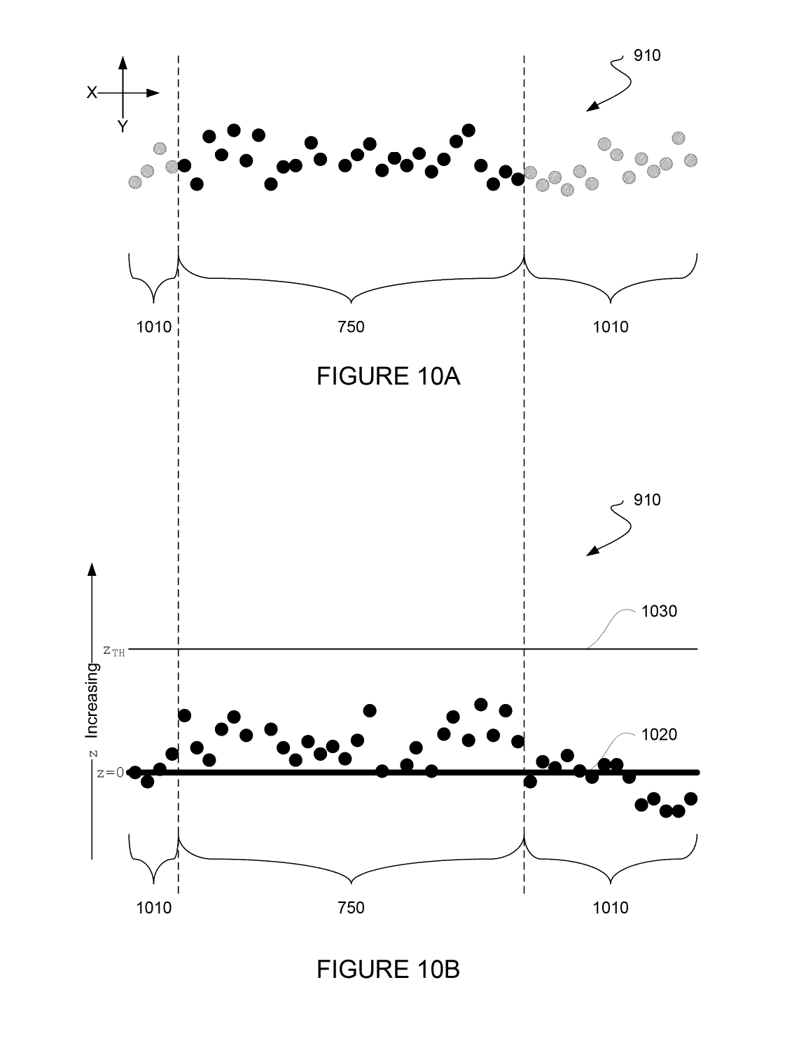

For example, FIG. 10A is a diagram of the x and y (latitude and longitude) coordinates a portion of the data points from section 910. As with the examples above, data points 750 are those associated with broken lane line 620 (shown in FIG. 6). FIG. 10B is a diagram of the elevation (z) of this same data. All of the data points in this example are close to roadway surface line 1020, and all are less than the threshold elevation line (z_{TH}) 1030. Thus, all of this data may be included in or considered for the set of lane marker data points.

Another criterion may be based on a threshold intensity value. The threshold intensity value may be a default value or a single value, or may be specific to a particular section. For example, the threshold intensity value may be the average intensity for a given section. In this example, the intensity value for each particular data point of a given section may be compared to the average intensity for the given section. If the intensity value of the data points for the given section is higher than the average intensity within the given section, these data points may be considered to be associated with a lane marker. In another example, the threshold intensity value for a given section may be some number (2, 3, 4, etc.) of standard deviations above the average intensity for the given section. Thus, the computer may filter or ignore data points which are below the threshold intensity value. In other words, data points at or above the threshold intensity value may be considered for or included in the set.

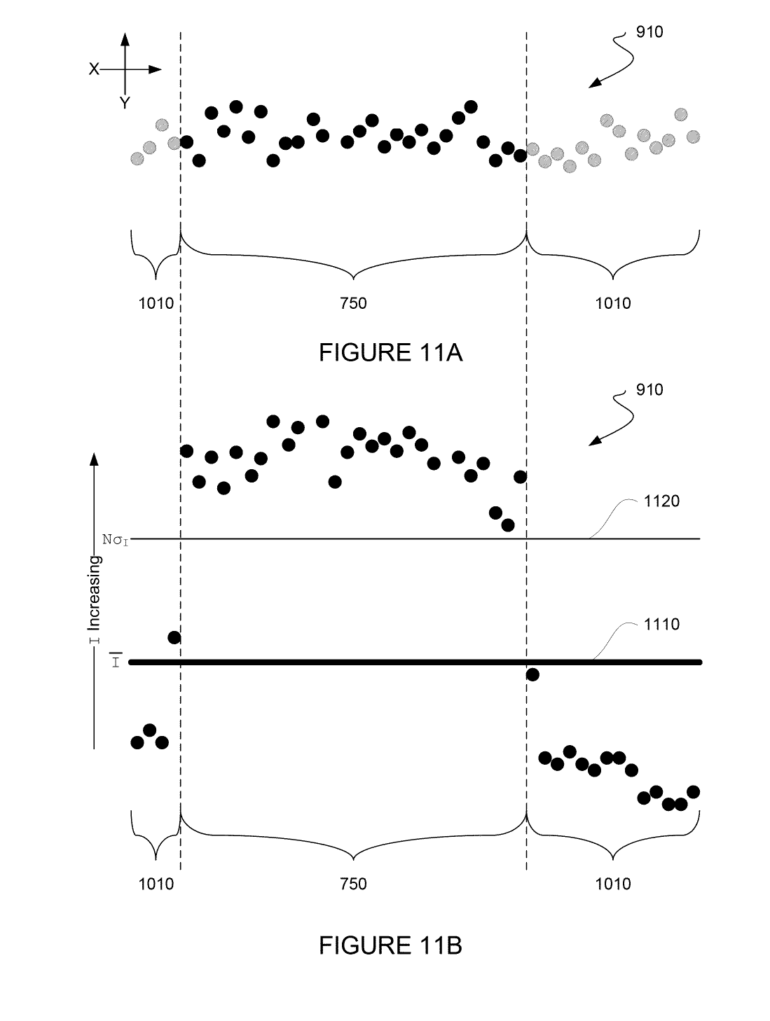

For example, like FIG. 10A, FIG. 11A is a diagram of the x and y (latitude and longitude) coordinates a portion of the data points from section 910. As with the examples above, data points 750 are those associated with broken lane line 620 (shown in FIG. 6). FIG. 11B is a diagram of the intensity (I) of this same data. This example also includes average intensity line (Ī) 1110 and the threshold number of standard deviations line (Nσ_{I}) 1120. In this example, data points 750 are above line 1120 (and may be significantly greater than line 1110) while data points 1010 are below line 1120 (and may not be significantly greater than line 1110). Thus, in this example data points 750 may be included in or considered for the set, while data points 1010 may be filtered or ignored.

Thus, considering the examples of both FIGS. 10B and 11B, data points 750 are more likely to be associated with a lane marker than data points 1010. Accordingly, data points 750 may be included in an identified set of lane marker data points for the beam, while data points 1010 may not.

The identified set of lane marker data points may also be filtered to remove less likely points. For example, each data points may be evaluated to determine whether it is consistent with the rest of the data points of the identified set of lane marker data points. The computer 110 (or computer 320) may determine whether the spacing between the data points of a set is consistent with typical lane markers. In this regard, lane marker data points may be compared to lane marker models 138. Inconsistent data points may be filtered or removed in order to reduce noise.

The filtering may also include examining clusters of high intensity data points. For example, in the case of 360 degree scan, adjacent points in the laser scan data may correspond to nearby locations in the world. If there is a group of two or more data points with relatively high intensities located close to one another (for example, adjacent to one another), these data points may be likely to correspond to the same lane marker. Similarly, high intensity data points which are not nearby to other high intensity data points or are not associated with a cluster may also be filtered from or otherwise not included in the identified set of lane marker data points.

The identified set of lane marker data points may also be filtered based on the location of the laser (or the vehicle) when the laser scan data was taken. For example, if the computer knows that the vehicle should be within a certain distance (in a certain direction) of a lane boundary, high intensity data points which are not close to this distance (in the certain direction) from the vehicle may also be filtered from or otherwise not included in the identified set of lane marker data points. Similarly, laser data points that are located relatively far (for example more than a predetermined number of yards, etc.) from the laser (or the vehicle) may be ignored or filtered from the identified set of lane marker data points if the laser scan data is noiser further away from the laser (or the vehicle).

The aforementioned steps may be repeated for each of the beams of the laser. For example, if there are 64 beams in a particular laser, there may be 64 filtered sets of lane maker data points.

The resulting filtered sets of lane marker data points may be stored for later use or simply made available for other uses. For example, the data may be used by a computer, such as computer 110, to maneuver an autonomous vehicle, such as vehicle 101, in real time. For example, the computer 110 may use the filtered sets of lane marker data to identify lane lines and to keep vehicle 101 in a lane. As the vehicle moves along the lane, the computer 110 may continue to process the laser data repeating all or some of the steps described above.

In some examples, the filtered sets of lane marker data may be determined at a later time by another computer, such as computer 320. For example, the laser scan data may be uploaded or transmitted to computer 320 for processing. The laser scan data may be processed as described above, and the resulting filtered sets of lane marker data may be used to generate, update, or supplement the map information used to maneuver the autonomous vehicles. Similarly, this information may be used to prepare maps used for navigation (for example, GPS navigation) and other purposes.

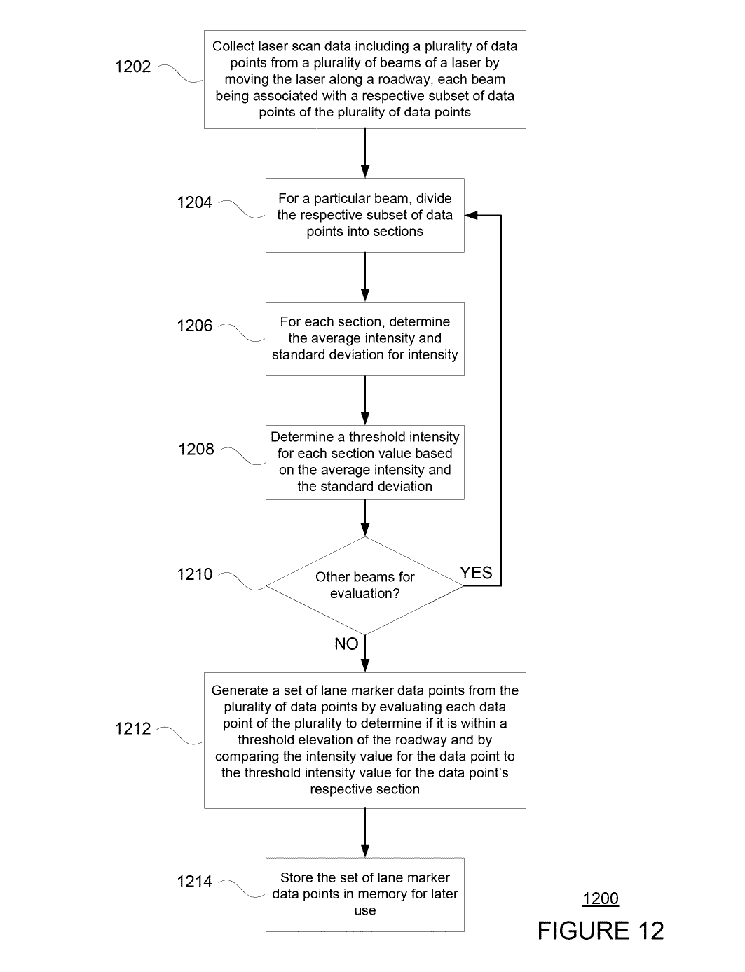

Flow diagram 1200 of FIG. 12 is an example of some of the aspects described above. Each of the following steps may be performed by computer 110, computer 320, or a combination of both. In this example, laser scan data including a plurality of data points from a plurality of beams of a laser is collected by moving the laser along a roadway at 1202. As noted above, the data points may describe intensity and location information for the objects from which the laser light was reflected. Each beam of the laser may be associated with a respective subset of data points of the plurality of data points.

For a single beam, the respective subset of data points is divided into sections at block 1204. For each section, the respective average intensity and the respective standard deviation for intensity are determined at block 1206. A threshold intensity for each section is determined based on the respective average intensity and the respective standard deviation for intensity at block 1208. If there are other beams for evaluation at block 1210, the process returns to block 1204 and the subset of data points for the next beam are evaluated as discussed above.

Returning to block 1210, if there are no other beams for evaluation, a set of lane marker data points from the plurality of data points is generated at block 1212. This includes evaluating each data point of the plurality to determine if it is within a threshold elevation of the roadway and by comparing the intensity value for the data point to the threshold intensity value for the data point's respective section. The set of lane marker data points may be stored in memory for later use or otherwise made available for further processing at block 1214.

While the examples described above include processing data points from each beam in succession, the same steps may be applied to any set of laser data that includes intensity values. For example, if there are multiple beams, the laser data for a single 360 scan may be processed all at once rather than beam by beam. In another example, the laser data may include only a single beam or the laser scan data may be received by the computer 110 or 320 without any indication of beams.

In this regard, the statistics (mean, standard deviation of intensity) may be calculated in a variety of different ways. For example, the laser scan data may be divided into sections having data from multiple beams rather than per-beam. Alternatively, all of the laser scan data for more than one or all of the beams may be processed all at once without dividing up the data points into sections. In addition, the statistics data for a scan of a particular section of roadway may be stored and compared offline (at a later time) to new laser scan data taken at the same location in the future.

In addition, the use of laser scan data including location, elevation, and intensities values may be replaced by any sensor that returns values that increase based on retro reflective and/or white materials (such as paint).

The aspects described above may provide additional benefits. For example, identifying data points that are very likely to be associated with lane markers, may reduce the time a processing power necessary to perform other processing steps. This may be especially important where the laser scan data is being processed in real time in order to maneuver an autonomous vehicle. Thus, the value of the savings in terms of time and processing power cost may be enormous.

As these and other variations and combinations of the features discussed above can be utilized without departing from the subject matter as defined by the claims, the foregoing description of exemplary implementations should be taken by way of illustration rather than by way of limitation of the subject matter as defined by the claims. It will also be understood that the provision of the examples described herein (as well as clauses phrased as “such as,” “e.g.”, “including” and the like) should not be interpreted as limiting the claimed subject matter to the specific examples; rather, the examples are intended to illustrate only some of many possible aspects.

1. A method comprising:
accessing scan data collected for a roadway, the scan data including a plurality of data points having location and intensity information for objects;
dividing the plurality of data points into sections;
for each section, identifying a threshold intensity;
generating, by a processor, a set of lane marker data points from the plurality of data points by evaluating each particular data point of the plurality by comparing the intensity value for the particular data point to the threshold intensity value for the section of the particular data point; and
storing the set of lane marker data points for later use.

2. The method of claim 1, wherein generating the set of lane marker data points further includes selecting data points of the plurality of data points having locations within a threshold elevation of the roadway.

3. The method of claim 1, wherein dividing the plurality of data points into sections includes processing a fixed number of data points.

4. The method of claim 1, wherein dividing the plurality of data points into sections includes dividing an area scanned by a laser into sections.

5. The method of claim 1, further comprising, before storing the set of lane marker data points, filtering the set of lane maker data points based on a comparison between the set of lane marker data points and models of lane markers.

6. The method of claim 1, further comprising, before storing the set of lane marker data points, filtering the set of lane maker data points based on identifying clusters of data points of the set of lane marker data points.

7. The method of claim 1, further comprising, before storing the set of lane marker data points, filtering the set of lane maker data points based on the location of the laser when the laser scan data was taken.

8. The method of claim 1, further comprising using the set of lane marker data points to maneuver an autonomous vehicle in real time.

9. The method of claim 1, further comprising using the set of lane marker data points to generate map information.

10. The method of claim 1, wherein the scan data is collected using a laser having a plurality of beams, and the accessed scan data is associated with a first beam of the plurality of beams, the method further comprising:
accessing second scan data associated with a second beam of the plurality of beams, the second scan data including a second plurality of data points having location and intensity information for objects;
dividing the second plurality of data points into second sections;
for each second section, evaluating the data points of the second section to determine a respective average intensity and a respective standard deviation for intensity;
for each second section, determining a threshold intensity based on the respective average intensity and the respective standard deviation for intensity;
generating a second set of lane marker data points from the second plurality of data points by evaluating each particular data point of the second plurality by comparing the intensity value for the particular data point to the threshold intensity value for the second section of the particular data point; and
storing the second set of lane marker data points for later use.

11. The method of claim 1, further comprising:
for each section, evaluating the data points of the section to determine a respective average intensity and a respective standard deviation for intensity; and
wherein identifying the threshold intensity for a given section is based on the respective average intensity and the respective standard deviation for intensity for the given section.

12. The method of claim 11, wherein identifying the threshold intensity for a given section includes multiplying the respective standard deviations by a predetermined value and adding the respective average intensity values.

13. The method of claim 1, wherein identifying the threshold intensity for the sections includes accessing a single threshold deviation value.

14. A device comprising:
memory for storing a set of lane marker data points;
a processor coupled to the memory, the processor being configured to:
access scan data collected for a roadway, the scan data including a plurality of data points having location and intensity information for objects;
divide the plurality of data points into sections;
for each section, evaluate the data points of the section to determine a respective average intensity and a respective standard deviation for intensity;
for each section, determine a threshold intensity based on the respective average intensity and the respective standard deviation for intensity;
generate a set of lane marker data points from the plurality of data points by evaluating each particular data point of the plurality comparing the intensity value for the particular data point to the threshold intensity value for the section of the particular data point; and
store the set of lane marker data points in the memory for later use.

15. The device of claim 12, wherein the processor is further configured to generate the set of lane marker data points by selecting data points of the plurality of data points having locations within a threshold elevation of the roadway.

16. The device of claim 12, wherein the processor is further configured to divide the plurality of data points into sections by processing a fixed number of data points.

17. The device of claim 12, wherein the processor is further configured to divide the plurality of data points into sections includes dividing an area scanned into sections.

18. The device of claim 12, wherein the processor is further configured to, before storing the set of lane marker data points, filter the set of lane maker data points based on a comparison between the set of lane marker data points and models of lane markers.

19. The device of claim 12, wherein the processor is further configured to, before storing the set of lane marker data points, filter the set of lane maker data points based on identifying clusters of data points of the set of lane marker data points.

20. The device of claim 12, wherein the processor is further configured to, before storing the set of lane marker data points, filter the set of lane maker data points based on the location of the laser when the laser scan data was taken.

21. The device of claim 12, wherein the processor is further configured to use the set of lane marker data points to maneuver an autonomous vehicle in real time.

22. The device of claim 12, wherein the processor is further configured to use the set of lane marker data points to generate map information.

23. The device of claim 12, wherein the processor is further configured to:
for each section, evaluate the data points of the section to determine a respective average intensity and a respective standard deviation for intensity; and
identify the threshold intensity for a given section based on the respective average intensity and the respective standard deviation for intensity for the given section.

24. The device of claim 23, wherein the processor is further configured to identify the threshold intensity for a given section by multiplying the respective standard deviations by a predetermined value and adding the respective average intensity values.

25. The device of claim 12, wherein the processor is further configured to identify the threshold intensity for the sections by accessing a single threshold deviation value.

26. A tangible computer-readable storage medium on which computer readable instructions of a program are stored, the instructions, when executed by a processor, cause the processor to perform a method, the method comprising:
accessing scan data collected for a roadway, the scan data including a plurality of data points having location and intensity information for objects;
dividing the plurality of data points into sections;
for each section, evaluating the data points of the section to determine a respective average intensity and a respective standard deviation for intensity;
for each section, determining a threshold intensity based on the respective average intensity and the respective standard deviation for intensity;
generating a set of lane marker data points from the plurality of data points by evaluating each particular data point of the plurality by comparing the intensity value for the particular data point to the threshold intensity value for the section of the particular data point; and
storing the set of lane marker data points for later use.
